(19) United States
(12) Patent Application Publication
(10) Pub. No.: US 2026/0171434 A1
(43) Pub. Date: Jun. 18, 2026

(54) BIPOLAR PLATE, FUEL CELL SYSTEM AND ELECTROLYZER

(71) Applicant: Robert Bosch GmbH, Stuttgart (DE)

(72) Inventors: Jan Willem Lenderink, Tilburg (NL); Lucas Prinsen, Rijen (NL); Markus Berger, Vaihingen An Der Enz (DE); Ulrich Sauter, Karlsruhe (DE)

(21) Appl. No.: 18/881,875

(22) PCT Filed: Jun. 12, 2023
(86) PCT No.: PCT/EP2023/065638

§ 371 Date: Jan. 7, 2025

(30) Foreign Application Priority Data
Jul. 7, 2022 (DE) 10 2022 206 952.8

(51) Int. Cl. H01M 8/0258; C25B 11/036; C25B 11/04; H01M 8/0206; H01M 8/0221; H01M 8/2483

(52) U.S. Cl. CPC H01M 8/0258; C25B 11/036; C25B 11/04; H01M 8/0206; H01M 8/0221; H01M 8/2483

(57) ABSTRACT

The present invention relates to a bipolar plate (100) for a chemical energy converter (200, 300). The bipolar plate (100) comprises:
a plurality of channels (101) for guiding operating media of the energy converter (200, 300),
a plurality of supply openings (103) for supplying the plurality of channels (101) with operating media,
a plurality of distribution channels (105) for distributing operating media to the plurality of channels (101),
   wherein respective distribution channels (105) of the plurality of distribution channels (105) extend between respective supply openings (103) of the plurality of supply openings (103) and respective channels (101) of the plurality of channels (101), and
   wherein respective supply openings (103) of the plurality of supply openings (103) have, on a distribution channel side which faces respective distribution channels (105) of the plurality of distribution channels (105), a curved edge region, at least in some regions.

### BACKGROUND

The present presented relates to a bipolar plate, a fuel cell system and an electrolyzer.

In cells of an energy converter, such as an electrolyzer or a fuel cell system, respective operating media, such as educts, are evenly distributed over a reactive surface of respective cells in order to achieve the best possible performance of the energy converter.

Distribution channels are used to distribute operating media provided by supply openings, i.e., so-called “ports,” on a reactive surface, which are typically arranged in a distribution field.

Supply openings that are the same size as a distribution field typically result in mechanically weak bipolar plates, such that such supply openings must be reinforced by means of bars. However, such bars appear detrimental for a flow rate flowing out of a respective supply opening.

### SUMMARY

Presented in the context of the invention presented are a bipolar plate, a fuel cell system and an electrolyzer. Further features and details of the invention arise from the respective dependent claims, the description, and the drawings. In this context, features and details described in connection with the bipolar plate according to the invention clearly also apply in connection with the fuel cell system according to the invention or the electrolyzer according to the invention, and respectively vice versa, so that mutual reference to the individual considerations of the invention always is or can be made with respect to the disclosure.

The invention presented serves in particular to enable efficient and robust operation of an energy converter.

Presented according to a first aspect of the invention presented is a bipolar plate for a chemical energy converter, such as a fuel cell system or an electrolyzer.

The present bipolar plate comprises a plurality of channels for guiding operating media of the energy converter, a plurality of supply openings for supplying the plurality of channels with operating media and a plurality of supply openings for distributing operating media provided by the plurality of supply openings to the plurality of channels, wherein respective distribution channels of the plurality of distribution channels extend between respective supply openings of the plurality of supply openings and respective channels of the plurality of channels, and wherein respective supply openings of the plurality of supply openings have, on a distribution channel side which faces respective distribution channels of the plurality of distribution channels, a curved edge region, at least in regions.

In the context of the present invention, a supply opening is to be understood as a so-called “port,” which comprises the bipolar plate in operation with operating media, such as fuel or water.

In the context of the present invention, a distribution channel is to be understood as a flow control device that directs the operating medium flowing out of a supply opening to respective channels or a reactive field of the bipolar plate. A distribution channel can be formed integrally from one channel or as a separate unit, in particular it consists of a different material than a respective channel of the bipolar plate. Of course, a distribution channel can also be made of the same material as a respective channel of the bipolar plate.

The present invention is based on the principle that respective supply openings of the plurality of supply openings have, on a distribution channel side which faces respective distribution channels of the plurality of distribution channels, a curved edge region.

The curved edge region of the supply channels of the bipolar plate presented allows the distribution channels to be arranged such that they are supplied evenly with operating media, even when the distribution channels are guided around respective bars for stabilizing the bipolar plate. Accordingly, a so-called “flow shadow,” i.e. a negative influence on a flow behavior of operating medium flowing out of a distribution opening, is prevented or minimized.

Furthermore, the curved edge region of the supply channels allows for particularly advantageous flow dynamics in the distribution field with a particularly compact distribution field geometry.

It may be provided that all distribution channels are the same length. By having equally long distribution channels, an even supply of channels of the bipolar plate presented is ensured by the distribution channels. The curved edge region of the supply openings allows the distribution channels to be guided the same length and around respective stabilizing bars.

It can further be provided that the respective supply openings with their distribution channel side abut the respective distribution channels and the respective distribution channels extend from the respective supply openings to the respective channels.

By aligning the curved distribution channel side of respective supply openings to respective distribution channels, additional space or additional surface area in which the distribution channels can extend is provided due to the bending of the edge region of the supply openings opposite a straight edge region.

It can further be provided that the respective distribution channels are at least partially oblique between the distribution channel side and respective channels.

Oblique distribution channels, i.e. distribution channels that run at an acute angle or an angle of less than 90°to a vertical axis of the bipolar plate, for example, allows respective distribution channels to be guided in the edge regions of a stabilizing bar around the stabilizing bar or past the stabilizing bar, such that an influence of the stabilizing bar on flow behavior of medium flowing through the distribution channels is minimized. The vertical axis can extend parallel to a long side of the bipolar plate, for example.

Of course, the plurality of distribution channels provided according to the invention can comprise straight distribution channels, i.e. that run parallel to the vertical axis, and oblique distribution channels. In particular, respective distribution channels adjacent to a stabilizing web may be oblique and respective distribution channels arranged in a central area of a respective distribution field may be straight.

It may further be contemplated that an angle between a respective distribution channel and a vertical axis of the bipolar plate differs from an angle between a further distribution channel and the vertical axis.

By means of distribution channel arranged at different angles to the vertical axis of the bipolar plate presented, i.e. a distributor channel-specific inclination or slope, an inclination of the distribution channels can be matched to a radius of curvature of a respective distribution opening, such that, regardless of the slope of a respective distribution channel, all distribution channels conduct an equal or comparable volume flow of operating medium to the channels of the bipolar plate presented.

It may further be contemplated that the distribution channels and the channels are comprised of different materials.

It can further be provided that the distribution channels are made of a plastic and the channels are made of a metal.

In order to ensure a precise configuration of the distribution channels provided according to the invention according to a predetermined arrangement, the distribution channels can be made of a particularly easy-to-form material, such as a plastic. Accordingly, the distribution channels in the form of a distribution filed can be pre-configured into a base body of the presented bipolar plate, which consists of, for example, a metal.

It may further be provided that the edge region of a respective supply opening is curved towards a center of the supply opening.

An edge region curved towards a center of the supply opening maximizes an area for distribution channels running between the edge region and respective channels of the bipolar plate presented.

It may further be provided that the bipolar plate comprises a number of stabilizing bars, in particular comprising a number of compensation channels for pressure and/or flow compensation between the supply openings.

Stabilizing bars maximize mechanical load capacity of the bipolar plate. By integrating equalizing channels into the stabilizing bars, an even distribution of pressure and/or flow forces is between respective regions of the bipolar plate separated by the stabilizing bars is achieved.

According to a second aspect, the present invention relates to a fuel cell system having a possible embodiment of the bipolar plate presented.

According to a third aspect, the invention presented relates to an electrolyzer comprising a possible embodiment of the bipolar plate presented.

### BRIEF DESCRIPTION OF THE DRAWINGS

Further advantages, features, and details of the invention arise from the following description, in which exemplary embodiments of the invention are described in detail with reference to the drawings. In this context, the features mentioned in the claims and in the description can each be essential to the invention individually or in any combination.

Shown are:

FIG. 1 a schematic representation of a possible configuration of the bipolar plate presented,

FIG. 2 one possible embodiment of the fuel cell system presented,

FIG. 3 one possible embodiment of the electrolyzer presented.

### DETAILED DESCRIPTION

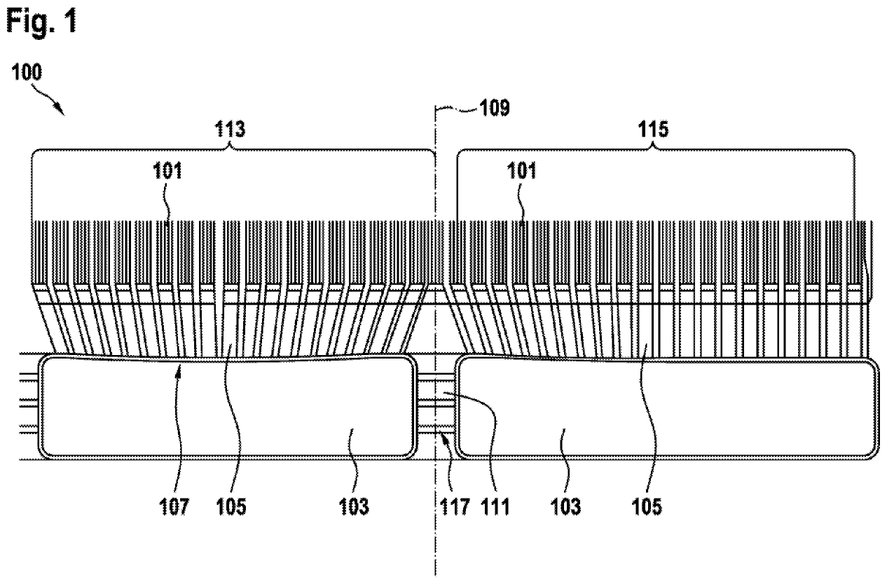

FIG. 1 shows a bipolar plate 100 for an energy converter, such as a fuel cell system or an electrolyzer.

The bipolar plate 100 comprises a plurality of channels 101 for guiding operating media of the energy converter. For example, the channels 101 form a reactive field or a reactive region of the bipolar plate 100.

Furthermore, the bipolar plate 100 comprises a plurality of supply openings 103 for supplying the channels 101 with operating media, or an operating medium, and a plurality of distribution channels 105 extending between the supply openings 103 and the channels 101.

The supply openings 103 are curved on a distribution channel side facing the distribution channels 105 in an edge region 107.

Furthermore, it can be clearly seen in FIG. 1 that the plurality of the distribution channels 105 are oblique to a vertical axis 109. All distribution channels 105 are the same length and guided around stabilizing bars 111.

Optionally, the stabilization bars 111 may comprises equalizing channels 117 that allow pressure and flow compensation between the supply openings 103.

While a distribution field 113 only comprises straight distribution channel 105, i.e. running parallel to the vertical axis 109, and otherwise inclined distribution channels 105, in a distribution field 115, inclined distribution channels 105 are arranged only in the outer edge region and otherwise straight distribution channels 105.

Due to the geometry of the distribution openings 103 and the distribution channels 105, the channels 101 are supplied with evenly with operating media.

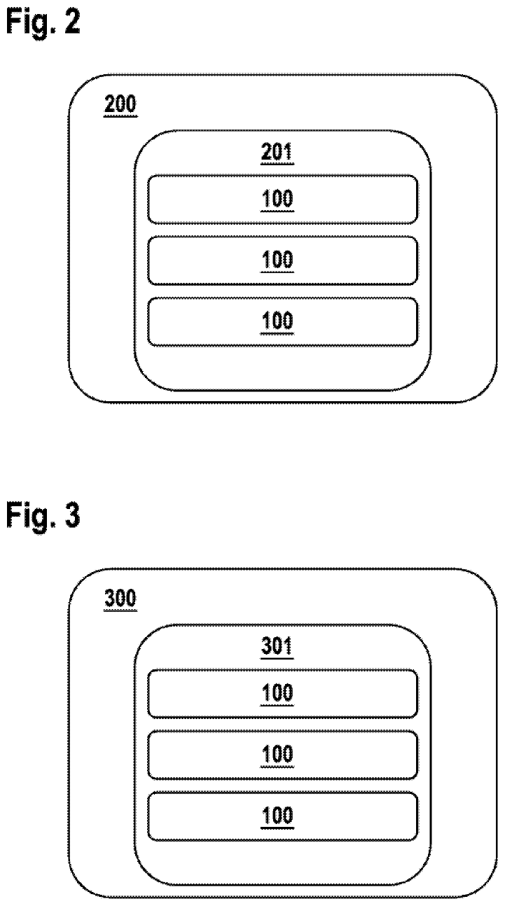

FIG. 2 shows a fuel cell system 200. The fuel cell system 200 comprises a fuel cell stack 201 having a plurality of bipolar plates 100, such as those shown in FIG. 1.

FIG. 3 shows an electrolyzer 300. The electrolyzer 300 comprises a cell stack 301 having a plurality of bipolar plates 100, such as those shown in FIG. 1.

1. A bipolar plate (100) for a chemical energy converter (200, 300),
wherein the bipolar plate (100) comprises:
a plurality of channels (101) for guiding operating media of the energy converter (200, 300),
a plurality of supply openings (103) for supplying the plurality of channels (101) with operating media,
a plurality of distribution channels (105) for distributing operating media to the plurality of channels (101),
wherein respective distribution channels (105) of the plurality of distribution channels (105) extend between respective supply openings (103) of the plurality of supply openings (103) and respective channels (101) of the plurality of channels (101), and
wherein respective supply openings (103) of the plurality of supply openings (103) have, on a distribution channel side which faces respective distribution channels (105) of the plurality of distribution channels (105), a curved edge region (107).

2. The bipolar plate (100) according to claim 1,
wherein
all distribution channels (105) are a same length.

3. The bipolar plate (100) according to claim 1,
wherein
the respective supply openings (103) have a distribution channel side abutting the respective distribution channels (105), and the respective distribution channels (105) extend from the respective supply openings (103) to the respective channels (101).

4. The bipolar plate (100) according to claim 1
wherein
the respective distribution channels (105) are at least partially oblique between a distribution channel side and respective channels (101).

5. The bipolar plate (100) according to claim 4,
wherein
an angle between a respective distribution channel (105) and a vertical axis (109) of the bipolar plate (100) differs from an angle between a further distribution channel (105) and the vertical axis (109).

6. The bipolar plate (100) according to claim 1,
wherein
the distribution channels (105) and the channels (101) are made of different materials.

7. The bipolar plate (100) according to claim 6,
wherein
the distribution channels (105) are made of a plastic and the channels (101) are made of a metal.

8. The bipolar plate (100) according to claim 1,
wherein
the curved edge region of a respective supply opening (103) is curved towards a center of the supply opening (103).

9. The bipolar plate (100) according to claim 1,
wherein
the bipolar plate comprises a number plurality of stabilizing bars (111), between the supply openings (103).

10. A fuel cell system (200),
wherein the fuel cell system (200) comprises a plurality of bipolar plates (100) according to claim 1.

11. An electrolyzer (300),
wherein the electrolyzer (300) comprises a plurality of bipolar plates (100) of claim 1.

12. The bipolar plate (100) according to claim 9, wherein the stabilizing bars (111) comprise a plurality of compensation channels (117) for pressure and/or flow compensation between the supply openings (103).
